(19) United States
(12) Patent Application Publication
(10) Pub. No.: US 2005/0177487 A1
(43) Pub. Date: Aug. 11, 2005

(54) System and method for estimating cash flow at risk for a non-financial institution

(76) Inventors: Jeremy Stein, Lexington, MA (US); Daniel A. Lagattuta, New York, NY (US); Stephen Usher, Keene, NY (US); Jeffrey R. Youngen, Arlington, VA (US)

Correspondence Address: BAKER & BOTTS, 30 ROCKEFELLER PLAZA, NEW YORK, NY, 10112, US

(21) Appl. No.: 10/415,206

(22) PCT Filed: Oct. 26, 2001
(86) PCT No.: PCT/US01/50932

Related U.S. Application Data
(60) Provisional application No. 60/243,460, filed on Oct. 26, 2000.

(51) Int. Cl. G06F 17/60

(52) U.S. Cl. 705/38

(57) ABSTRACT

A method for estimating cash flow at risk for a non-financial entity over a particular future time period, including receiving quarterly data associated with at least two of a plurality of non-financial entities, generating a plurality of data elements, each of the plurality of data elements representing a portion of the quarterly data of an associated one of the at least two of the plurality of non-financial entities, selecting one of the at least two of the plurality of non-financial entities, and estimating the cash flow at risk for the selected one of the at least two of the plurality of non-financial entities based on at least two of the plurality of data elements.

### RELATED APPLICATIONS

This invention claims priority from (and incorporates in whole by reference Provisional Application No. 60/243,460, filed Oct. 26, 2000.

### FIELD OF THE INVENTION

The present invention relates to corporate finance. In particular, the present invention relates to the estimation of cash flow at risk for a non-financial institution.

### BACKGROUND OF THE INVENTION

Financial institutions use value-at-risk (VaR) measures to project asset values in the near future, for example by days or weeks, so that the financial institutions can balance their respective debt-equity ratio, or utilize derivatives to hedge commodity-price exposures to manage risk over the short term. Typically VaR is estimated using a “bottom up” method. The bank begins by enumerating each of the bank's assets, for example, each loan, trading position, etc. The risk exposures for each of the bank's assets, i.e. to interest rate shocks, credit risk, foreign exchange movements, etc., are then quantified. The risks are aggregated across the bank's entire portfolio of assets and VaR is calculated. VaR works well to the extent that a bank can identify each of its main sources of risk, and these sources of risk correspond, either directly or indirectly, to traded assets, for which there is good historical data on price movements. In particular, this method is very well suited to evaluating the risks of a trading desk that deals in relatively liquid instruments.

A “bottom-up” VaR type analysis of the cash flows at risk for non-financial institutions has also been used so that the non-financial institution can balance its debt-equity ratio, or utilize derivatives to hedge commodity-price exposures to manage risk over the short term. However, conducting a “bottom-up” VaR type analysis of non-financial institutions is complicated by the fact that each risk faced by a non-financial institution may not be related to a clearly identifiable asset. Additionally, the asset held by the non-financial institution is not likely to be traded frequently, nor is it likely to have good historical data on price movements. For example, one of Company X's assets may be a marketing campaign, and one of the risks associated with the marketing campaign may be public approval of Company X's marketing campaign. Company X's marketing campaigns are not traded and good historical data on Company X's marketing campaigns may not be readily available, thus making it all but impossible to calculate an accurate VaR which reflects the risk to Company X's marketing effort.

A “top down” analysis of the cash flows at risk for a non-financial institution has also been used so that the non-financial institution can balance its debt-equity ratio, or utilize derivatives to hedge commodity-price exposures to manage risk over the mid-term. The advantage of conducting a “top down” analysis for non-financial institutions is that a “top down” analysis should summarize the combined effect of all relevant risks facing a particular non-financial institution. Unfortunately, data availability presents a problem. Generally, only quarterly data is available for a non-financial institution, such that to obtain a statistically valid number of samples of cash flow at risk for a particular non-financial institution more than two decades of data will have to be used. This presents a problem because many non-financial institutions did not exist twenty years ago, and even for the non-financial institutions that did exist twenty years ago, the cash flows at risk twenty years ago are not relevant to the cash flows at risk currently.

### SUMMARY OF THE INVENTION

The present invention in one aspect is a method for estimating cash flow at risk for a non-financial entity over a particular future time period. In accordance with a first exemplary embodiment of the method of the present invention, there is provided a method for estimating cash flow at risk for a non-financial entity over a particular future time period, including receiving quarterly data associated with at least two of a plurality of non-financial entities, generating a plurality of data elements, each of the plurality of data elements representing a portion of the quarterly data of an associated one of the at least two of the plurality of non-financial entities, selecting one of the at least two of the plurality of non-financial entities, and estimating the cash flow at risk for the selected one of the at least two of the plurality of non-financial entities based on at least two of the plurality of data elements.

In accordance with a first exemplary embodiment of the system of the present invention, there is provided a computer system including means for receiving quarterly data associated with at least two of a plurality of non-financial entities, means for generating a plurality of data elements, each of said plurality of data elements representing a portion of said quarterly data of an associated one of said at least two of said plurality of non-financial entities, means for selecting one of said at least two of said plurality of non-financial entities, and means for estimating said cash flow at risk for said selected one of said at least two of said plurality of non-financial entities based on at least two of said plurality of data elements.

### BRIEF DESCRIPTION OF THE DRAWINGS

Further objects, features, and advantages of the invention will become apparent from the following detailed description taken in conjunction with the accompanying figures showing illustrative embodiments of the invention, in which:

FIG. 1 is a flow chart illustrating a process for preparing quarterly income statement data and quarterly balance-sheet data according to the present invention;

FIG. 2 is a flow chart illustrating a process for generating a cash flow at risk profile for a selected non-financial firm according to the present invention;

FIG. 3 is a flow chart illustrating a process for dividing the data points stored in the database into standard peer groups according to the present invention;

FIG. 4 is a flow chart illustrating a process for creating a custom peer group for the selected non-financial firm according to the present invention; and

FIG. 5 is a flow chart illustrating a process for creating an industry peer group for the selected non-financial firm according to the present invention.

Throughout the figures, unless otherwise stated, the same reference numerals and characters are used to denote like features, elements, components, or portions of the illustrated embodiments. Moreover, while the subject invention will now be described in detail with reference to the figures, and in connection with the illustrative embodiments, changes and modifications can be made to the described embodiments without departing from the true scope and spirit of the subject invention as defined by the appended claims.

### DETAILED DESCRIPTION OF THE INVENTION

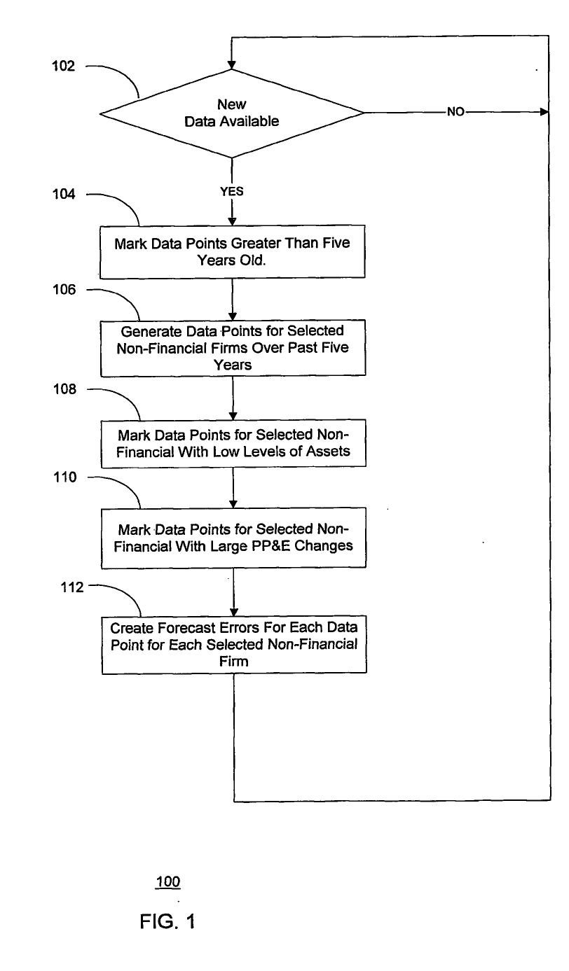

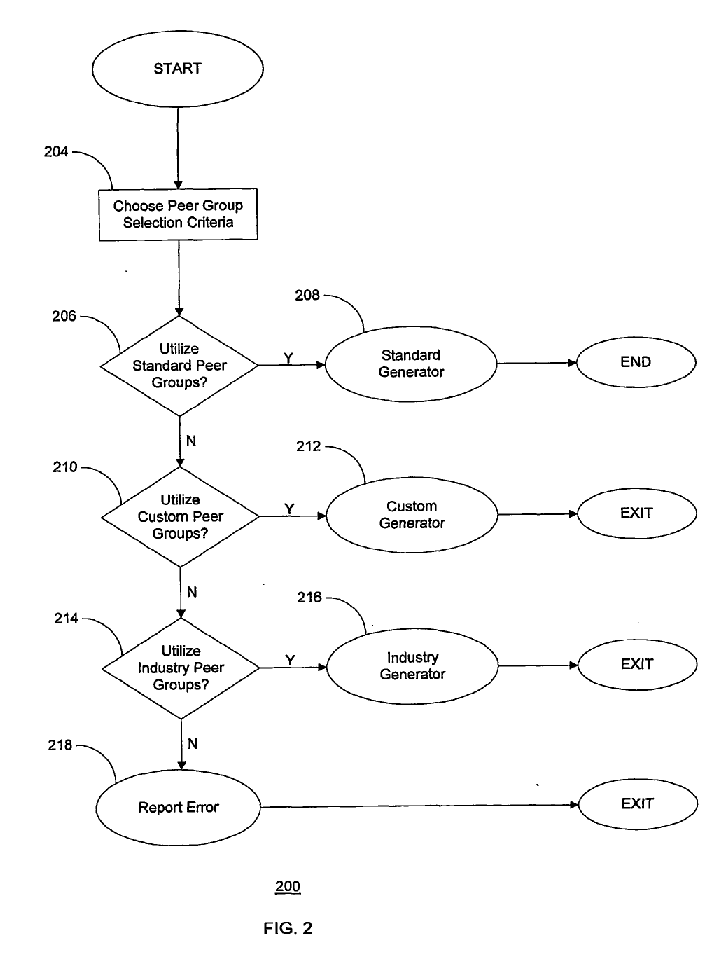

FIG. 1 illustrates a process 100. The process 100 prepares quarterly income statement data and quarterly balance-sheet data for use by a process 200 (shown in FIG. 2) whereby a cash flow at risk profile is generated for a specific non-financial firm. The cash flow at risk profile for the specific non-financial firm is used to predict the specific non-financial firm's earnings before interest, taxes, depreciation and amortization (hereinafter “EBITDA”) per assets forecast error over the next quarter and the next year. In a certain embodiment, the cash flow at risk profile predicts a specific non-financial firm's EBITDA per assets forecast error given a five percent tail event over the next quarter or year. In another certain embodiment, the cash flow at risk profile predicts a specific non-financial firm's EBITDA per assets forecast error given a one percent tail event and a five percent tail event over the next quarter or year.

The process 100 begins at step 102. At step 102, the process 100 determines whether new data has become available. The process 100 uses quarterly income statement data and quarterly balance-sheet data from a selected group of non-financial firms. In a certain embodiment, the quarterly income statement data and quarterly balance-sheet data is obtained from Compustat Expressfeed, version 2.0, Standard & Poors, 55 Water Street, New York, N.Y. 10041. If new data becomes available, the process 100 advances to step 104. If no new data has become available, the process 100 advances to step 102.

At step 104, the process 100 marks out-dated data points stored in a database associated with the process 100 such that the out-dated data point is not used in any analysis. Each data point represents quarterly income statement data and quarterly balance-sheet data for one of the group of selected non-financial firms. A data point is a data structure which may include multiple values indicating the quarter, for example, Q1 1994, EBITDA for the quarter, assets for the quarter, market capitalization for the quarter, average income to assets for the quarter, annualized stock price volatility during the quarter, industry cashflow volatility, industry group identifier, i.e. SIC code, EBITDA per asset forecast error for a quarter ahead, and EBITDA per asset forecast error for a year ahead. The EBITDA per asset forecast error for a quarter ahead and EBITDA per asset forecast error for a year ahead will be described in more detail with reference to step 112. The process 100 marks any data points which are out-dated to keep the population of data points reflective of the current business environment. Preferably, the process 100 marks any data point which is more than five years old. Once the out-dated data points are removed, the process 100 advances to step 106.

At step 106, the process 100 retrieves any available quarterly income statement data and quarterly balance-sheet data for the selected group of non-financial firms for quarters which are not currently reflected by the data points stored in the database and for quarterly income statement data and quarterly balance-sheet data that has been updated, generates data points representing that data, and stores the generated data points in the database. When any published quarterly data is not reflected by any of the data points in the database or when any published quarterly data is updated so that it is not accurately reflected by any of the data points in the database, the process 100 preferably retrieves that quarterly data for the non-financial firm. The process 100 extracts the relevant data from the retrieved quarterly income statement data and quarterly balance-sheet data creating a data point reflecting that data, and stores that data point in the database. One data point should be created representing the quarterly data for each of the selected non-financial firms. Retrieving and storing available data points for the selected group of non-financial companies keeps the population of data points stored in the database current. Preferably, the process 100 retrieves data points which are no more than five years old. In a certain embodiment, the selected non-financial firms are those firms for which quarterly income statement data and quarterly balance-sheet data is available to the public. Once the available data points are stored, the process 100 advances to step 108.

At step 108, the process 100 marks a first portion of the new data points such that they are not used to generate a cash flow at risk profile. Data points for non-financial firms where the value of book assets for the non-financial firm for a particular quarter fall below a particular predetermined level are marked such that they are not used to generate a cash flow at risk profile. In a certain embodiment, the data points for non-financial firms which fall within the lowest five percent of book assets in any given quarter are so marked. By eliminating the data points for non-financial firms with low values of book assets from the analysis, the ratio of EBITDA per assets does not become unboundedly large. Once the data points for non-financial firms with low values of book assets are marked, the process 100 advances to step 110.

At step 110, the process 100 marks a second portion of the data points such that the second portion of data points are not used in the calculation of the cash flow at risk profile. The data points for non-financial firms where the property plant and equipment (hereinafter “PP&E”) for the non-financial firm experience dramatic changes from one quarter to the next are removed from the database. In a certain embodiment, the data points for non-financial firms where the PP&E changes by more than fifty percent are removed. By so marking the data points for non-financial firms with dramatic changes in PP&E, large mergers and other dramatic changes in a company's asset base, which are not surprises from the non-financial firm's point of view, but which induce a great deal of volatility in measured EBITDA per assets, are eliminated from the analysis. Once the data points for non-financial firms with dramatic changes in PP&E are marked, the process 100 advances to step 112.

In a certain embodiment, the data points for non-financial firms where the PP&E changes by as little as twenty percent are marked.

In step 112, the process 100 generates EBITDA per asset forecast errors for each new data point received. An EBITDA per asset forecast error is the difference between the forecasted EBITDA per asset amount for a given time period and the actual EBITDA per asset amount for the given time period. EBITDA per asset forecast errors are calculated for quarter ahead forecasts and year ahead forecasts. A linear regression algorithm is used to create the coefficients and constant values which are then used in an equation to forecast the quarter ahead forecast and the year ahead forecast. A PROC REG of the SAS/SAT Software, version 8.0, from the SAS Institute, Inc., SAS Campus Drive, Cary, N.C., 27513-2414, is used to perform the linear regression.

When the PROC REG performs a quarter ahead linear regression, the quarter-ahead regression used to estimate the parameters used to create the quarter-ahead forecast is the following equation (hereinafter “equation (1)”):

$$\begin{matrix}{( \frac{Income}{Assets} )}_{i , t} = {( Coef Lag1 )}_{R} \cdot {( \frac{Income}{Assets} )}_{i , t - 1} + {( Coef Lag2 )}_{R} \cdot \\ {( \frac{Income}{Assets} )}_{i , t - 2} + {( Coef Lag3 )}_{R} \cdot {( \frac{Income}{Assets} )}_{i , t - 3} + \\ {( Coef Lag4 )}_{R} \cdot {( \frac{Income}{Assets} )}_{i , t - 4} + {( Coef Q1 Dummy )}_{R} \cdot \\ {( Q1 Dummy )}_{t} + {( Coef Q2 Dummy )}_{R} \cdot \\ {( Q2 Dummy )}_{t} + {( Coef Q3 Dummy )}_{R} \cdot \\ {( Q3 Dummy )}_{t} + {Constant}_{R} + {ɛ}_{t , i , R}\end{matrix}$$

where the income-to-assets ratio for company i in quarter t is defined by the following equation (hereinafter “equation (2)”):

$${( \frac{Income}{Assests} )}_{i , t} = \frac{{EBITDA}_{i , t}}{{Assets}_{i , t - 1}}$$

where EBITDA_{i,t} is the EBITDA for company i in quarter t in the five-year period R, and Assets_{i,t-1} is the total assets for company i at the end of quarter t−1 (and hence the total assets at the beginning of quarter t). The season dummy variables (Q1 Dummy)ₜ, (Q2 Dummy)ₜ, and (Q3 Dummy)ₜ are defined by the following equation (hereinafter “equation (3)”):
(Qq Dummy)ₗ=1 if quarter t equals calendar quarter q, 0 otherwise.
The ε_{t,i,R} term in Equation 1 is the in-sample error term in the regression for company i in quarter t using the data in the five-year period R

Once the coefficients have been calculated for a given five-year period R, the coefficients are used to forecast the income-to-assets ratio for the first quarter beyond this five-year period according to the following equation (hereinafter “equation (4)”):

$$\begin{matrix}{( \frac{Income}{Assets} )}_{i , Max ( R ) + 1}^{Forecast} = {( Coef Lag1 )}_{R} \cdot {( \frac{Income}{Assets} )}_{i , Max ( R )} + \\ {( Coef Lag2 )}_{R} \cdot {( \frac{Income}{Assets} )}_{i , Max ( R ) - 1} + \\ {( Coef Lag3 )}_{R} \cdot {( \frac{Income}{Assets} )}_{i , Max ( R ) - 2} + \\ {( Coef Lag4 )}_{R} \cdot {( \frac{Income}{Assets} )}_{i , Max ( R ) - 3} + \\ {( Coef Q1 Dummy )}_{R} \cdot {( Q1 Dummy )}_{Max ( R ) + 1} + \\ {( Coef Q2 Dummy )}_{R} \cdot {( Q2 Dummy )}_{Max ( R ) + 1} + \\ {( Coef Q3 Dummy )}_{R} \cdot {( Q3 Dummy )}_{Max ( R ) + 1} + \\ {Constant}_{R}\end{matrix}$$

where the Max(R)+1 notation is used to indicate the first quarter beyond the five-year period R. For example, by using data for the five-year period from 1989Q1 to 1993Q4, we can forecast the income-to-assets ratio for quarter 1994Q1 using Equation 4, data from 1989Q2 to 1994Q1 to forecast the ratio for quarter 1994Q2, etc. By rolling the five-year period forward, forecasted quarter ahead income-to-assets ratios for each company i for each quarter from 1994Q1 to latest quarter for which we have data can be generated.

After the quarter ahead forecasts are generated for the income-to-assets ratio, the quarter-ahead forecasted income-to-assets error for company i in quarter t may be calculated by the following equation (hereinafter “equation (5):

$${( Forecast Error )}_{i , t}^{Quarter \text{-} Ahead} = {( \frac{Income}{Assets} )}_{i , t}^{Forecast} - {( \frac{Income}{Assets} )}_{i , t} .$$

The set of (Forecast Error)_{i,t}^{Quarter-Ahead} is all companies i and all quarters t which are within five years of the quarter in question. Once the EBITDA per asset forecast error for a quarter ahead is calculated it is stored in the associated data point.

When the PROC REG performs a year ahead linear regression, the year ahead regression used to estimate the parameters used to create the year ahead forecasts is the following equation (hereinafter “equation (6)”):

$$\begin{matrix}{( \frac{Yearly Income}{Assets} )}_{i , t} = {( Coef Lag1 )}_{R}^{′} \cdot {( \frac{Income}{Assets} )}_{i , t - 1} + \\ {( Coef Lag2 )}_{R}^{′} \cdot {( \frac{Income}{Assets} )}_{i , t - 2} + \\ {( Coef Lag3 )}_{R}^{′} \cdot {( \frac{Income}{Assets} )}_{i , t - 3} + \\ {( Coef Lag4 )}_{R}^{′} \cdot {( \frac{Income}{Assets} )}_{i , t - 4} + \\ {( Coef Q1 Dummy )}_{R}^{′} \cdot {( Q1 Dummy )}_{t} + \\ {( Coef Q2 Dummy )}_{R}^{′} \cdot {( Q2 Dummy )}_{t} + \\ {( Coef Q3 Dummy )}_{R}^{′} \cdot {( Q3 Dummy )}_{t} + \\ {Constant}_{R}^{′} + {ɛ}_{i , t , R}^{′}\end{matrix}$$

where yearly income to assets ration is defined by the following equation (hereinafter “equation (7)”):

$${( \frac{Yearly Income}{Assets} )}_{i , t} = \frac{{EBITDA}_{i , t} + {EBITDA}_{i , t + 1} + {EBITDA}_{i , t + 2} + {EBITDA}_{it + 3}}{{Assets}_{i , t - 1}}$$

The forecasted yearly-income-to-asset ratio for the first quarter after a given five-year period R is then calculated by the following equation (hereinafter “equation (8)”):

$$\begin{matrix}{( \frac{Yearly Income}{Assets} )}_{i , Max ( R ) + 1}^{Forecast} = {( Coef Lag1 )}_{R}^{′} \cdot {( \frac{Income}{Assets} )}_{i , Max ( R )} + \\ {( Coef Lag2 )}_{R}^{′} \cdot {( \frac{Income}{Assets} )}_{i , Max ( R ) -} \\ {( Coef Lag3 )}_{R}^{′} \cdot {( \frac{Income}{Assets} )}_{i , Max ( R ) - 2} + \\ {( Coef Lag4 )}_{R}^{′} \cdot {( \frac{Income}{Assets} )}_{i , Max ( R} \\ {( Coef Q1 Dummy )}_{R}^{′} \cdot \\ {( Q1 Dummy )}_{Max ( R ) + 1} + \\ {( Coef Q2 Dummy )}_{R}^{′} \cdot \\ {( Q2 Dummy )}_{Max ( R ) + 1} + \\ {( Coef Q3 Dummy )}_{R}^{′} \cdot \\ {( Q3 Dummy )}_{Max ( R ) + 1} + \\ {Constant}_{R}^{′}\end{matrix}$$

Finally, the year ahead forecast error is defined by the following equation (hereinafter “Equation (9)”):

$${( Forecast Error )}_{i , t}^{Year \text{-} Ahead} = {( \frac{Yearly Income}{Assets} )}_{i , t}^{Forecast} - {( \frac{Yearly Income}{Assets} )}_{i , t} .$$

The set of (Forecast Error)_{i,t}^{Year-Ahead} is all companies i and all quarters t which are within five years of the quarter in question. The set of year ahead forecast errors stops three quarters before the set of quarter ahead forecast errors, since four leads of actual data are required for calculating the year ahead forecast error. Once the EBITDA per asset forecast error for a quarter ahead is calculated it is stored in the associated data point. Once the year ahead EBITDA per asset forecast errors and the quarter ahead EBITDA per asset forecast errors are stored in the associated data point, the process 100 advances to step 102.

FIG. 2 illustrates the process 200 which generates a cash flow at risk profile for a selected non-financial firm. The process 200 starts when it receives an indication of which non-financial firm for which to generate a cash flow at risk profile. Once the process 200 receives an indication of which non-financial firm to generate a cash flow at risk profile for, the process 200 advances to step 204.

At step 204, the process 200 waits to receive an indication of which peer group selection criteria are to be used in selecting the peer group for the particular non-financial firm. A peer group can be selected on any characteristic relevant to the non-financial firm's business, but four characteristics of a non-financial firm's business are strongly associated with patterns in forecast-error volatility: market capitalization, average income to assets, industry cashflow volatility, and annualized stock price volatility. Market capitalization is calculated for a particular data point based on the non-financial firm's market capitalization for the particular quarter. Average income to assets is calculated for a particular data point as the average value of EBITDA per assets over the prior four quarters. Annualized stock price volatility is calculated using daily stock price data over the current quarter. Industry cashflow volatility is calculated as the log of squared residuals of in-sample variances, ln(ε²_{i,t,R}), from the quarter ahead regression discussed above in connection with step 112 of process 100, illustrated in FIG. 1, and regressing those values, using linear regression, against: the dummy variables for the industry identifiers controlling for market capitalization, EBITDA per assets, and stock volatility. The process 200 uses PROC REG to perform the linear regression. When the PROC REG performs the linear regression, the PROC REG is attempting to generate the coefficient on an industry's dummy (Coef Industry) for the following equation (hereinafter “equation (10)”):

$$\begin{matrix}ln ( {ɛ}_{i , t , R}^{2} ) = {( Coef Market Cap )}_{R} \cdot ln ( {( Market Cap )}_{i , t - 1} ) + \\ {( Coef Income \text{-} to \text{-} Assets )}_{R} \cdot {〈 \frac{Income}{Assets} 〉}_{i , t - 1} + \\ {( Coef Stock Vol )}_{R} \cdot {( Stock Volatility )}_{i , t - 1} + \\ {\sum }_{all SIC3} {( Coef Industry )}_{R , SIC3} \cdot {( SIC3 Dummy )}_{i , SIC3}\end{matrix}$$

where (Market Cap)_{i,t} is the market capitalization expressed in units of millions of dollars for company i at the end of quarter t, (Stock Volatility)_{i,t} is the annualized stock volatility for company i for quarter t, and <Income per Assets>_{i,t} is the average EBITDA per assets for the last four quarters. The dummy variables for the three digit SIC codes in Equation (10) are defined by: (SIC3 Dummy)_{i, SIC3} equals one if company i has a three digit SIC code equal to the industry code for the non-financial firm associated with the particular data point, otherwise (SIC3 Dummy)_{i, SIC3} equals zero. The higher the coefficient on an industry's dummy (Coef Industry), the riskier that industry is deemed to be. Once the selected peer group selection criteria are received, the process 200 advances to step 206.

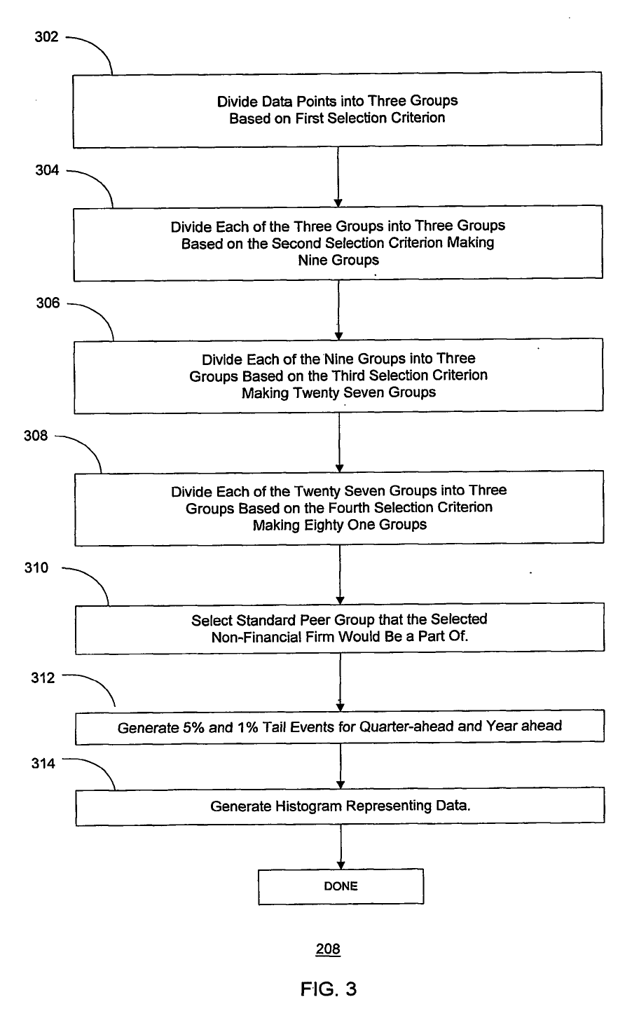

At step 206, the process 200 determines whether standard peer groups are to be utilized in generating the cash flow at risk profile. If the standard peer groups are to be used, the process 200 advances to step 208. The step 208 generates a cash flow at risk profile using standard peer groups. Once the step 208 is complete, the process 200 exits. The step 208 is shown in more detail in FIG. 3. If standard peer groups are not to be used, the process 200 advances to step 210.

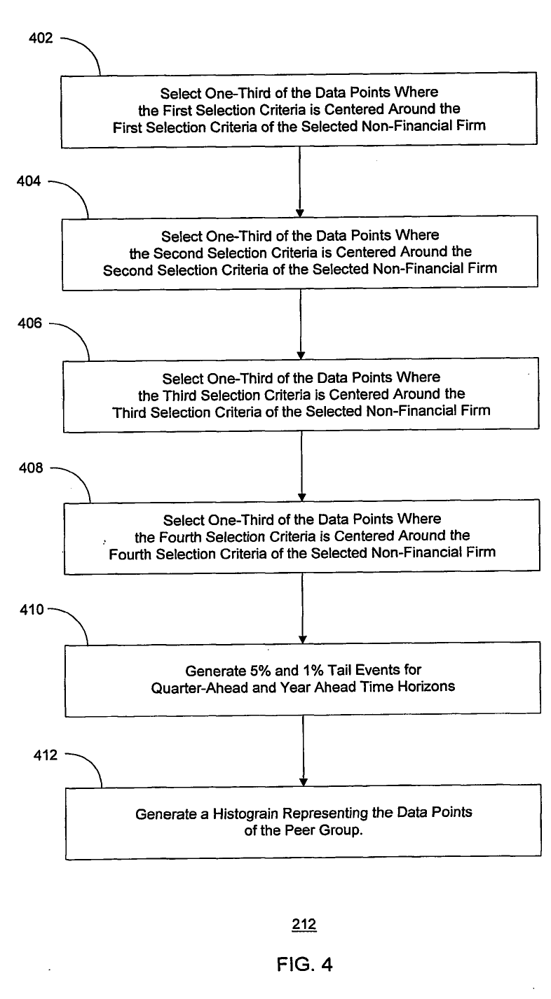

At step 210, the process 200 determines whether custom peer groups are to be utilized in generating the cash flow at risk profile. If custom peer groups are to be used, the process 200 advances to step 212. The step 212 generates a cash flow at risk profile using custom peer groups. Once the step 212 is complete, the process 200 exits. The step 212 is shown in more detail in FIG. 4. If standard peer groups are not to be used, the process 200 advances to step 214.

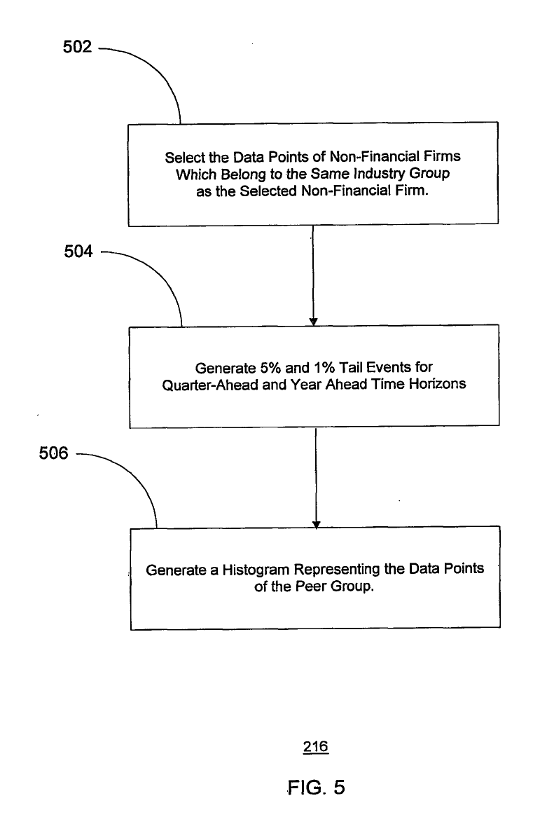

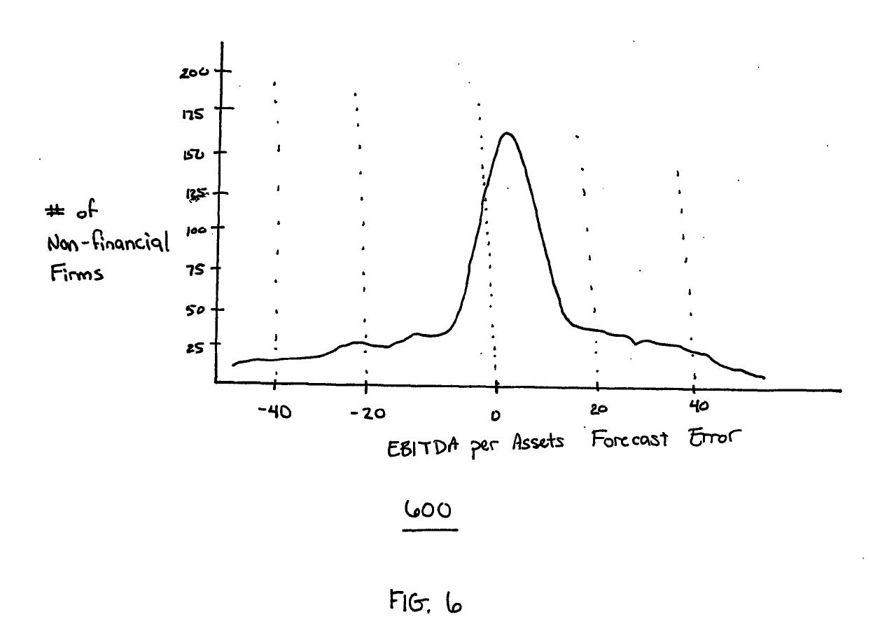

At step 214, the process 200 determines whether industry peer groups are to be utilized in generating the cash flow at risk profile. If industry peer groups are to be used, the process 200 advances to step 216. The step 216 generates a cash flow at risk profile using industry peer groups. Once the step 216 is complete, the process 200 exits. The step 216 is shown in more detail in FIG. 5. If industry peer groups are not to be used, the process 200 advances to step 218.

At step 218, the process 200 reports an error. The user must specify that standard peer groups, custom peer groups or industry peer groups are to be used to generate the cash flow at risk profile, otherwise an error is reported. Once the error is reported, the process 200 exits.

FIG. 3 illustrates the process 208, which divides the data points stored in the database into standard peer groups. The process 208 begins at step 302. At step 302, the process 208 divides the data points into three groups based on the first selection criteria. The first group having a third of the data points with the smallest first criterion, the third group having a third of the data points with the largest first criterion, and the second group having the remaining third of the data points. In a certain embodiment, the first criterion is the prior quarter's value of market capitalization, the first group having the third of the data points with small market capitalization, the second group having the third of the data points with medium market capitalization, and the third group having the third of the data points with large market capitalization. A data point may only belong to one of the three groups. Once the data points are divided into three groups, the process 208 advances to step 304.

At step 304, the process 208 further divides each of the three groups into three groups based on the second selection criteria, making a total of nine groups. Each of the three groups of data points are divided into three groups, the first group having the third of the data points with the smallest second criterion, the third group having the third of the data points with the largest second criterion, and the second group having the remaining third of the data points. In a certain embodiment, the second criterion is average income to assets, the first group having the third of the data points with the smallest average income to assets, the second group having the third of the data points with medium average income to assets, and the third group having the third of the data points with the largest average income to assets. Once each of the three groups of data points are divided into three additional groups, making a total of nine groups, the process 208 advances to step 306.

At step 306, the process 208 further divides each of the nine groups into three groups based on the third selection criteria, making a total of twenty seven groups. Each of the nine groups of data points are divided into three groups, the first group having the third of the data points with the smallest third criterion, the third group having the third of the data points with the largest third criterion, and the second group having the remaining third of the data points. In a certain embodiment, the third criterion is industry cashflow volatility, the first group having the third of the data points with the smallest industry cashflow volatility, the second group having the third of the data points with a medium about of industry cashflow volatility, and the third group having the third of the data points with the largest industry cashflow volatility. Once each of the nine groups of data points are divided into three additional groups, making a total of twenty seven groups, the process 208 advances to step 308.

At step 308, the process 208 further divides each of the twenty seven groups into three groups based on the fourth selection criteria, making a total of eighty one groups. Each of the twenty seven groups of data points are divided into three groups, the first group having the third of the data points with the smallest fourth criterion, the third group having the third of the data points with the largest fourth criterion, and the second group having the remaining third of the data points. In a certain embodiment, the fourth criterion is the prior quarter's value of annualized stock price volatility, the first group having the third of the data points with the smallest annualized stock price volatility, the second group having the third of the data points with a medium amount of annualized stock price volatility, and the third group having the third of the data points with the largest annualized stock price volatility. Once each of the twenty seven groups of data points are divided into three additional groups, making a total of eighty one groups, the process 208 advances to step 310.

At step 310, the process 208 selects one of the eighty one standard peer groups from which to generate a cash flow at risk profile. The process 208 selects the one of the eighty one standard peer groups within which the selected non-financial firm would be placed given the selection criteria. Once the process 208 selects the one of the eighty one standard peer groups, the process 208 advances to step 312.

At step 312, the process 208 generates the values for the five percent and one percent tail events for quarter ahead forecasting error and year ahead forecasting error for the one of the eighty one standard peer groups. A five percent tail event for a quarter ahead forecast error is the quarter ahead forecast error EBITDA per assets for the data point with the highest quarter ahead forecast error EBITDA per assets of the one of the eighty one groups that is within lowest five percent of the data points contained within the one of the eighty one groups. A one percent tail event for a quarter ahead forecast error is a measurement of the quarter ahead forecast error EBITDA per assets for the data point with the highest quarter ahead forecast error EBITDA per assets of the one of the eighty one groups that is within the lowest one percent of the data points contained within the one of the eighty one groups. A five percent tail event for a year ahead forecast error is a measurement of the year ahead forecast error EBITDA per assets for the data point with the highest year ahead forecast error EBITDA per assets of the one of the eighty one groups that is within the lowest five percent of the data points contained within the one of the eighty one groups. A one percent tail event for a year ahead forecast error is a measurement of the year ahead forecast error EBITDA per assets for the data point with the highest year ahead forecast error EBITDA per assets of the one of the eighty one groups that is within the lowest one percent of the data points contained within the one of the eighty one groups. Once the tail events are calculated, the process 208 advances to step 314.

At step 314, the process 208 generates a histogram representing the number of data points versus forecast error EBITDA per assets. The number of data points of the one of the eighty one groups having a particular forecast error EBITDA per assets is represented on the y-axis. The forecast error EBITDA per assets is represented on the x-axis. An exemplary histogram 600 is provided as FIG. 6. Once the process 208 generates the histogram representing the number of data points versus forecast error EBITDA per assets, the process 208 exits.

FIG. 4 illustrates the process 212, which creates a custom peer group for the selected non-financial firm. The process 212 begins at step 402. At step 402, the process 212 begins creating a first custom peer group. The process 212 creates the first custom peer group having one third of the data points stored in the database whereby the data points contained within the first custom peer group have first selection criteria values centered around the value of the first selection criteria of the selected non-financial firm. In a certain embodiment, the first criterion is market capitalization. Once the first custom peer group is created, the process 212 advances to step 404.

At step 404, the process 212 refines the custom peer group. The process 212 creates a second custom peer group having one third of the data points contained within the first custom peer group whereby the data points contained within the second custom peer group have second selection criteria values centered around the value of the second selection criteria of the selected non-financial firm. In a certain embodiment, the second criterion is average income to assets. Once the second custom peer group is created, the process 212 advances to step 406.

At step 406, the process 212 refines the custom peer group further. The process 212 creates a third custom peer group having one third of the data points contained within the second custom peer group whereby the data points contained within the third custom peer group have third selection criteria values centered around the value of the third selection criteria of the selected non-financial firm. In a certain embodiment, the third criterion is industry cashflow volatility. Once the third custom peer group is created, the process 212 advances to step 408.

At step 408, the process 212 refines the custom peer group still further. The process 212 creates a fourth custom peer group haying one third of the data points contained within the third custom peer group whereby the data points contained within the fourth custom peer group have fourth selection criteria values centered around the value of the fourth selection criteria of the selected non-financial firm. In a certain embodiment, the fourth criterion is annualized stock price volatility. Once the fourth custom peer group is created, the process 212 advances to step 410.

At step 410, the process 212 generates the values for the five percent and one percent tail events for quarter ahead forecasting error and year ahead forecasting error for the fourth custom peer group. A five percent tail event for a quarter ahead forecast error is the quarter ahead forecast error EBITDA per assets for the data point with the highest quarter ahead forecast error EBITDA per assets of the fourth custom peer group that is within the lowest five percent of the data points contained within the fourth custom peer group. A one percent tail event for a quarter ahead forecast error is a measurement of the quarter ahead forecast error EBITDA per assets for the data point with the highest quarter ahead forecast error EBITDA per assets of the fourth custom peer group that is within the lowest one percent of the data points contained within the fourth custom peer group. A five percent tail event for a year ahead forecast error is a measurement of the year ahead forecast error EBITDA per assets for the data point with the highest year ahead forecast EBITDA per assets of the fourth custom peer group that is within the lowest five percent of the data points contained within the fourth custom peer group. A one percent tail event for a year ahead forecast error is a measurement of the year ahead forecast error EBITDA per assets for the data point with the highest year ahead forecast error EBITDA per assets of the fourth custom peer group that is within the lowest one percent of the data points contained within the fourth custom peer group. Once the tail events are calculated, the process 212 advances to step 412.

At step 412, the process 212 generates a histogram representing the number of data points versus forecast error EBITDA per assets for the data points of the fourth custom peer group. The number of data points of the fourth custom peer group having a particular forecast error EBITDA per assets is represented on the y-axis. The forecast error EBITDA per assets is represented on the x-axis. Once the process 212 generates the histogram representing the number of data points versus forecast error EBITDA per assets, the process 212 exits.

FIG. 5 illustrates the process 216, which creates an industry peer group for the selected non-financial firm. The process 216 begins at step 502. At step 502, the process 216 creates the industry peer group by selecting each data point stored within the data base having the same industry group code as the selected non-financial firm. Using an industry peer group is only effective if the industry has a significant number of non-financial firms such that a significant number of forecast errors are available. It may be particularly useful to use an industry peer group if there are specific questions about the industry that cannot be answered if non-financial firms from different industries are included within the peer group. Once the industry peer group is created, the process 216 advances to step 504.

At step 504, the process 216 generates the values for the five percent and one percent tail events for quarter ahead forecasting error and year ahead forecasting error for the industry peer group. A five percent tail event for a quarter ahead forecast error is the quarter ahead forecast error EBITDA per assets for the data point with the highest quarter ahead forecast error EBITDA per assets of the industry peer group that is within the lowest five percent of the data points contained within the industry peer group. A one percent tail event for a quarter ahead forecast is a measurement of the quarter ahead forecast error EBITDA per assets for the data point with the highest quarter ahead forecast error EBITDA per assets of the industry peer group that is within the lowest one percent of the data points contained within the industry peer group. A five percent tail event for a year ahead forecast is a measurement of the year ahead forecast error EBITDA per assets for the data point with the highest year ahead forecast error EBITDA per assets of the industry peer group that is within the lowest five percent of the data points contained within the industry peer group. A one percent tail event for a year ahead forecast error is a measurement of the year ahead forecast error EBITDA per assets for the data point with the highest year ahead forecast error EBITDA per assets of the industry peer group that is within the lowest one percent of the data points contained within the industry peer group. Once the tail events are calculated, the process 216 advances to step 506.

At step 506, the process 216 generates a histogram representing the number of data points versus forecast error EBITDA per assets for the data points of the industry peer group. The number of data points of the industry peer group having a particular forecast error EBITDA per assets is represented on the y-axis. The forecast error EBITDA per assets is represented on the x-axis. Once the process 212 generates the histogram representing the number of data points versus forecast error EBITDA per assets, the process 216 exits.

The invention has been described in connection with certain preferred embodiments thereof. It will be appreciated that those skilled in the art can modify or alter such embodiments without departing from the scope and spirit of the invention which is set forth in the appended claims.

1. A computer-implemented method for estimating cash flow at risk for a non-financial entity over a particular future time period, comprising:
receiving quarterly data associated with at least two of a plurality of non-financial entities;
generating a plurality of data elements, each of said plurality of data elements representing a portion of said quarterly data of said at least two of said plurality of non-financial entities;
selecting one of said at least two of said plurality of non-financial entities;
estimating by computer analysis said cash flow at risk for said selected one of said at least two of said plurality of non-financial entities based on at least two of said plurality of data elements, wherein one of the at least two of said plurality of data elements represents at least a portion of said quarterly data of said selected one of said at least two of said plurality of non-financial entities, and wherein another of the at least two of said plurality of data elements represents at least a portion of said quarterly data of another of said at least two of said plurality of non-financial entities; and
providing an output of said estimate whereby an end user or additional computer processing may make use of the output.

2. The method of claim 1, wherein each of said plurality of data elements includes:
an indication of a calendar quarter to which the data element pertains; and
an indication of a year to which the data element pertains.

3. The method of claim 1, wherein each of said plurality of data elements includes:
an indication of earnings before interest, taxes, depreciation and amortization for said indicated calendar quarter of said indicated year of said associated one of said at least two of said plurality of non-financial entities;
an indication of assets for said indicated calendar quarter of said indicated year of said associated one of said at least two of said plurality of non-financial entities; and
an indication of actual earnings before interest, taxes, depreciation and amortization per assets, said indication of actual earnings before interest, taxes, depreciation and amortization per assets calculated by dividing said indication of earnings before interest, taxes, depreciation and amortization for said indicated calendar quarter of said indicated year by said indication of assets for said indicated calendar quarter of said indicated year.

4. The method of claim 3, wherein each of the plurality of data elements further comprises:
an indication of market capitalization for said indicated calendar quarter of said indicated year of said associated one of said at least two'of said plurality of non-financial entities;
an indication of average income to assets for said indicated calendar quarter of said indicated year of said associated one of said at least two of said plurality of non-financial entities;
an indication of annualized stock price volatility during said indicated calendar quarter of said indicated year of said associated one of said at least two of said plurality of non-financial entities;
an indication of an industry to which said associated one of said at least two of said plurality of non-financial entities belongs; and
an indication of cashflow volatility of said industry to which said associated one of said at least two of said plurality of non-financial entities belongs.

5. The method of claim 4, wherein each of the plurality of data elements includes an indication of an earnings before interest, taxes, depreciation and amortization per asset forecast error for one quarter in the future for said associated one of said at least two-of said plurality of non-financial entities.

6. The method of claim 5, wherein said indication of earnings before interest, taxes, depreciation and amortization for per asset forecast error for one quarter in the future is calculated by generating an earnings before interest, taxes, depreciation and amortization per asset forecast for one quarter in the future for said associated one of said at least two of said plurality of non-financial entities using linear regression, and subtracting said indication of earnings before interest, taxes, depreciation and amortization per asset forecast for one quarter in the future from said indication of actual earnings before interest, taxes, depreciation and amortization per asset.

7. The method of claim 4, wherein each of the plurality of data elements includes an indication of an earnings before interest, taxes, depreciation and amortization per asset forecast error for one year in the future for said associated one of said, at least two of said plurality of non-financial entities.

8. The method of claim 7, wherein said indication of earnings before interest, taxes, depreciation and amortization for per asset forecast error for one year in the future is calculated by generating an earnings before interest, taxes, depreciation and amortization per asset forecast for one year in the future for said associated one of said at least two of said plurality of non-financial entities using linear regression, and subtracting said indication of earnings before interest, taxes, depreciation and amortization per asset forecast for one year in the future from said indication of actual earnings before interest, taxes, depreciation and amortization per asset.

9. The method of claim 8, wherein said plurality of data elements includes one thin of said plurality of data elements, said one third of said plurality of data elements having said indication of market capitalization centered around said indication of market capitalization of one of said plurality of data elements associated with said selected one of the plurality of non-financial entities.

10. The method of claim 9, wherein said estimating step further comprises determining a five percent tail event for a forecast error by selecting said quarter ahead forecast error earnings before interest, taxes, depreciation and amortization per assets fox one quarter in the future of one of said one third of said plurality of data elements with the highest forecast error earnings before interest, taxes, depreciation and amortization per assets for one quarter in the future of said one third of said at least two of the; plurality of data elements that is within the lowest five percent of the data elements contained within said one third of said plurality of data elements.

11. The method of claim 9, wherein said estimating step further comprises determining a one percent tail event for a forecast error by selecting said quarter ahead forecast error earnings before interest, taxes, depreciation and amortization per assets for one quarter in the future of one of said one third of said plurality of data elements with the highest forecast error earnings before interest, taxes, depreciation and amortization per assets for one quarter in the future of said one third of said at least two of the plurality of data elements that is within the lowest one percent of the data elements contained within said one third of said plurality of data elements.

12. The method of claim 9, wherein said estimating step further comprises determining a five percent tail event for a forecast error by selecting said year ahead forecast error earnings before interest, taxes, depreciation and amortization per assets for one year in the future of one of said one third of said plurality of data elements with the highest forecast error earnings before interest, taxes, depreciation and amortization per assets for one year in the future of said one third of said at least two of the plurality of data elements that is within the lowest five percent of the data elements contained within said one third of said plurality of data elements.

13. The method of claim 9, wherein said estimating step further comprises determining a one percent tail event for a forecast error by selecting said year ahead forecast error earnings before interest, taxes, depreciation and amortization per assets for one year in the future of one of said one third of said plurality of data elements with the highest forecast error earnings before interest, taxes, depreciation and amortization per assets for one year in the future of said one third of said at least two of the plurality of data elements that is within the lowest one percent of the data elements contained within said one third of said plurality of data elements.

14. The method of claim 8, wherein said plurality of data elements includes one third of said plurality of data elements, said one third of said plurality of data elements having said indication of average income to assets centered around said indication of average income to assets of one of said plurality of data elements associated with said selected one of the plurality of non-financial entities.

15. The method of claim 8, wherein said plurality of data elements includes one third of said plurality of data elements, said one third of said plurality of data elements having said indication of annualized stock price volatility centered around said indication of annualized stock price volatility of one of said plurality of data elements associated with said selected one of the plurality of non-financial entities.

16. The method of claim 8, wherein said plurality of data elements includes one third of said plurality of data elements, said one third of said plurality of data elements having said indication of cashflow volatility of the industry centered around said indication of cashflow volatility of the industry of one of said plurality of data elements associated with said selected one of the plurality of non-financial entities.

17. The method of claim 8, wherein said plurality of data elements include each of the plurality of data elements having said indication of said industry which is the same as said indication of said industry of one of said plurality of data elements associated with said selected one of said at least two of said plurality of non-financial firms.

18. A computer system comprising:
means for receiving quarterly data associated with at least two of a plurality of non-financial entities;
means for generating a plurality of data elements, each of said plurality of data elements representing a portion of said quarterly data of an associated one of said at least two of said plurality of non-financial entities;
means for selecting one of said at least two of said plurality of non-financial entities; and
means for estimating said cash flow at risk for said selected one of said at least two of said plurality of non-financial entities based on at least two of said plurality of data elements, wherein one of the at least two of said plurality of data elements represents at least a portion of said quarterly data of said selected one of said at least two of said plurality of non-financial entities, and wherein another of the at least two of said plurality of data elements represents at least a portion of said quarterly data of another of said at least two of said plurality of non-financial entities.

19. The system of claim 18, wherein each of the plurality of data elements includes:
an indication of earnings before interest, taxes, depreciation and amortization for said indicated calendar quarter of said indicated year of said associated one of said at least two of said plurality of non-financial entities;
an indication of assets for said indicated calendar quarter of said indicated year said associated one of said at least two of said plurality of non-financial entities; and
and indication of actual earnings before interest, taxes, depreciation and amortization per assets, said indication of actual earnings before interest, taxes, depreciation and amortization per assets calculated by dividing said indication of earnings before interest, taxes, depreciation and amortization for said indicated calendar quarter of said indicated year by said indication of assets for said indicated calendar quarter of said indicated year.

20. The system of claim 19, wherein each of the plurality of data elements further includes:
an indication of market capitalization for said indicated calendar quarter of said indicated year of said associated one of said at least two of said plurality of non-financial entities;
an indication of average income to assets for said indicated calendar quarter of said indicated year of said associated one of said at least two of said plurality of non-financial entities;

21. The system of claim 20, wherein each of the plurality of data elements includes an indication of an earnings before interest, taxes, depreciation and amortization per asset forecast error for one quarter in the future for said associated one of said at least two of said plurality of non-financial entities.

22. The system of claim 21, wherein said plurality of data elements includes one third of said plurality of data elements, said one third of said plurality of data elements having said indication of market capitalization centered around said indication of market capitalization of one of said plurality of data elements associated with said selected one of the plurality of non financial entities.

23. The system of claim 22, wherein said estimating step further comprises determining a five percent tail event for a forecast error by selecting said quarter. ahead forecast error earnings before interest, taxes, depreciation and amortization per assets for one quarter in the future of one of said one third of said plurality of data elements with the highest forecast error earnings before interest, taxes, depreciation and amortization per assets for one quarter in the future of said one third of said at least two of the plurality of data elements that is within the lowest five percent of the data elements contained within said one third of said plurality of data elements.
